(19) United States
(12) Patent Application Publication
(10) Pub. No.: US 2026/0222317 A1
(43) Pub. Date: Jul. 30, 2026

(54) METHOD, APPARATUS, AND SYSTEM FOR MULTIPLEXING WIRELESS COMMUNICATION WITH AI-BASED USER SEPARATION

(71) Applicant: CHUNG ANG UNIVERSITY INDUSTRY ACADEMIC COOPERATION FOUNDATION, Seoul (KR)

(72) Inventors: Jung Ryun LEE, Seoul (KR); Ki Ho LEE, Yongin-si (KR)

(21) Appl. No.: 19/382,899

(22) Filed: Nov. 7, 2025

(30) Foreign Application Priority Data
Jan. 24, 2025 (KR) 10-2025-0011822

(51) Int. Cl. H04L 41/16; H04L 5/02

(52) U.S. Cl. CPC H04L 41/16; H04L 5/023

(57) ABSTRACT

A multiplexing wireless communication system operating in a shared embedding space over a communication channel for AI-based user separation, comprising: a plurality of transmitting devices, each configured to: map a user's data sequence to first embedding data using a first positional encoding for semantic identification; map the first embedding data to second embedding data using a second positional encoding for user identification; and output the second embedding data; an embedding-domain multiplexer configured to combine, by embedding-space superposition, the second embedding data from the plurality of transmitting devices into a single multiplexed signal; and a receiving device configured to: receive the single multiplexed signal; perform attention-driven masking and AI-based alignment conditioned on user-specific information to separate user signals in the embedding domain; and decode semantic information for each user.

### CROSS-REFERENCE TO RELATED APPLICATION

This application claims priority under 35 U.S.C. § 119 (a) of Korean Patent Application No. 10-2025-0011822, filed on Jan. 24, 2025, with the Korean Intellectual Property Office, the entire contents of which are incorporated herein by reference.

### BACKGROUND

### (a) Technical Field

The present disclosure relates to a multiplexing wireless communication method, apparatus, and system for AI-based user separation, and more particularly, to a method, apparatus, and system for separating user-specific signals based on artificial intelligence (AI) while minimizing inter-user interference.

### (b) Background Art

In a wireless communication environment where multiple users share the same frequency band or resources, various multiple access techniques have been developed to reduce between users and support efficient communication. Representative methods include the following:

Time Division Multiple Access (TDMA) divides users into time slots such that each user utilizes the resources only during its assigned time slot.

This prevents resource collisions and offers the advantage of simple implementation; however, due to the fixed time slot allocation, inefficiency arises when a user fails to complete data transmission within the assigned slot, and it is limited in handling dynamic traffic.

The Frequency Division Multiple Access (FDMA) scheme divides the frequency band into multiple sub-bands, with each user utilizing a different frequency.

This prevents frequency collisions and is advantageous for users requiring fixed bandwidth; however, due to the fixed bandwidth allocation to each user, resource efficiency is reduced and adaptability in dynamic environments is limited.

Code Division Multiple Access (CDMA) allows multiple users to share the same frequency band by employing different spreading codes.

This allows dynamic resource allocation and provides flexibility in both frequency and time domains; however, it is highly sensitive to interference and requires complex design to mitigate inter-code interference.

Finally, the Orthogonal Frequency Division Multiple Access (OFDMA) scheme divides the frequency spectrum into smaller subcarriers and dynamically allocates the subcarriers among users.

This provides high spectral efficiency and robustness against multipath fading; however, it involves complexity in synchronization and management, and may incur high processing delay.

These conventional techniques are limited in their ability to satisfy the requirements of next-generation networks such as 5G and 6G, which demand high data rates, low latency, and support for a massive number of users.

With the increasing complexity of networks and the expansion in the number of users, there is a demand for more efficient and flexible data processing methods.

Static resource allocation schemes are inefficient and may cause network performance to deteriorate significantly as the number of users increases. In addition, when multiple users share the same resources, such schemes have inherent limitations in effectively reducing interference.

Furthermore, as the network size grows or the number of users increases, conventional approaches lack scalability, fail to reflect real-time variations in user demands and channel conditions, and may suffer from reduced transmission accuracy under diverse wireless environments such as multipath fading and additive white Gaussian noise (AWGN).

### SUMMARY OF THE DISCLOSURE

In order to solve the problems of the prior art described above, the present disclosure seeks to propose a multiplexing wireless communication method, apparatus, and system for AI-based user separation that minimizes inter-user signal interference and supports efficient and reliable data transmission in next-generation wireless communication environments where multiple users share the same wireless resources.

To accomplish the above object, according to the present disclosure, the multiplexing wireless communication system operating in a shared embedding space over a communication channel for AI-based user separation, comprising: a plurality of transmitting devices, each configured to: map a user's data sequence to first embedding data using a first positional encoding for semantic identification; map the first embedding data to second embedding data using a second positional encoding for user identification; and output the second embedding data; an embedding-domain multiplexer configured to combine, by embedding-space superposition, the second embedding data from the plurality of transmitting devices into a single multiplexed signal; and a receiving device configured to: receive the single multiplexed signal; perform attention-driven masking and AI-based alignment conditioned on user-specific information to separate user signals in the embedding domain; and decode semantic information for each user.

The first positional encoding emphasizes task-level semantic features and the second positional encoding emphasizes user identification.

The mapping with the second positional encoding is implemented by an operator selected from element-wise multiplication, element-wise addition, or a hybrid of multiplication and addition.

The second positional encoding is configured to increase separation among embedding vectors of different users in the embedding space according to a distance metric selected from cosine distance, Euclidean distance, angular distance, or Mahalanobis distance, thereby facilitating subsequent user-specific separation.

The embedding-domain multiplexer forms the single multiplexed signal by a weighted sum or average of the second embedding data, optionally with a normalization factor based on the number of users.

The plurality of transmitting devices comprises a Transformer encoder and the receiving device comprises a Transformer decoder, the Transformer encoder converts each second embedding data to a hidden state, the embedding-domain multiplexer superposes the hidden state from the plurality of transmitting devices into a single multiplexed signal, the Transformer decoder with masked multi-head attention conditioned on the second positional encoding to recover user-specific embeddings.

The receiving device comprises a Transformer encoder-decoder, the Transformer encoder to the single multiplexed signal to produce a hidden state, and applies the Transformer decoder with masked multi-head attention conditioned on the second positional encoding to recover user-specific embeddings.

The receiving device reconstructs, for each user, at least one of: a symbol sequence, a class label, and a reconstructed sample, from the recovered user-specific embeddings.

Parameters of the first positional encoding, the second positional encoding, and the Transformer encoder-decoder are jointly learned in an end-to-end pre-training stage and stored for inference.

The pre-training stage includes unified training in which token-level samples are drawn across multiple channel environments using a single parameter set.

The pre-training stage includes per-channel training in which separate parameter sets are trained for different channel environments.

The pre-training stage further includes a contrastive objective that increases inter-user separation in the embedding space using an InfoNCE (Information Noise-Contrastive Estimation) loss.

The second positional encoding is applied to encoder outputs at the receiver to form user-specific decoder inputs by element-wise interaction between a user encoding and an output embedding.

The first positional encoding and the second positional encoding are implemented as distinct trainable vectors or matrices of a common embedding dimension.

The receiving device estimates an alignment factor that quantifies attention-driven interference alignment among users and adjusts masking based on the alignment factor.

According to another aspect of the present disclosure, a method for multiplexing wireless communication in a shared embedding space over a communication with AI-based user separation, comprising: mapping, by a plurality of transmitting devices, each user's data sequence to first embedding data using a first positional encoding for semantic identification; mapping, by the plurality of transmitting devices, the first embedding data to second embedding data using a second positional encoding for user identification; combining, by embedding-space superposition, the second embedding data into a single multiplexed signal; receiving, by a receiving device, the single multiplexed signal; and separating user signals and decoding semantic information by applying attention-driven masking and AI-based alignment with a Transformer encoder-decoder.

According to the present disclosure, AI-based multiplexing can be achieved in wireless communication environments, providing the advantage of maximizing the efficiency of data reconstruction.

In addition, according to the present disclosure, advantages include minimizing inter-user interference, providing optimal performance in diverse environments, improving data transmission accuracy, and enabling efficient utilization of network resources.

Furthermore, according to the present disclosure, advantages include large-scale network scalability, compatibility with next-generation networks, and the ability to perform real-time data transmission and recovery.

### BRIEF DESCRIPTION OF DRAWINGS

FIG. 1 is a diagram illustrating the configuration of a multiplexing wireless communication system for AI-based user separation according to a preferred embodiment of the present invention.

FIG. 2 is a diagram illustrating a multiplexing wireless communication process for AI-based user separation according to the present embodiment.

FIG. 3 is a diagram illustrating a multiplexing wireless communication scheme for AI-based user separation based on a Transformer according to the present embodiment.

FIG. 4 is a diagram illustrating a multiplexing wireless communication method for Transformer-based user separation according to another embodiment of the present invention.

FIG. 5 illustrates a PCA visualization of user-specific positional encodings.

FIG. 6 illustrates pairwise correlations between positional encodings for 10 users.

FIG. 7 illustrates the relationship among SNR, loss, and accuracy.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “~ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

The present embodiment proposes semantic communication, which differs from conventional communication systems that prioritize bit-level accuracy, and is directed to delivering contextually relevant and meaningful information.

To this end, the present embodiment proposes a method of multiplexing and reconstructing user signals in wireless communication based on deep learning techniques including a Transformer.

The present embodiment employs AI models, such as Transformers, to directly learn semantic features from data, thereby attaining improved robustness and efficiency in communication.

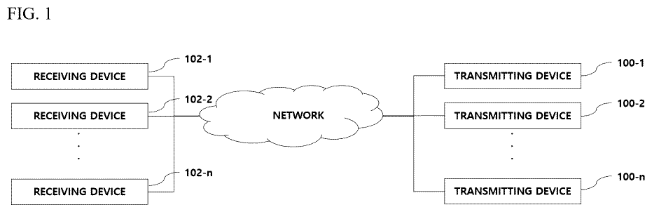

FIG. 1 is a diagram illustrating the configuration of a multiplexing wireless communication system for AI-based user separation according to a preferred embodiment of the present invention.

As illustrated in FIG. 1, the wireless communication system according to the present embodiment may include a plurality of transmitting devices (100-1, 100-2, . . . , 100-n) and a receiving device (102-1, 102-2, . . . , 102-n).

The plurality of transmitting devices (100-1, 100-2, . . . , 100-n) and the receiving devices (102-1, 102-2, . . . , 102-n) may be connected through a network such as a mobile communication network.

The transmitting devices (100-1, 100-2, . . . , 100-n) and the receiving devices (102-1, 102-2, . . . , 102-n) may include a processor and a memory storing program instructions for performing predetermined operations, wherein the processor executes the program instructions to enable multiplexing wireless communication for AI-based user separation.

The plurality of transmitting devices (100-1, 100-2, . . . , 100-n) may be ordinary mobile communication terminals for transmitting user data, and the plurality of receiving devices (102-1, 102-2, . . . , 102-n) may be other mobile communication terminals or base stations; however, they are not limited thereto, and cases in which the plurality of transmitting devices (100-1, 100-2, . . . , 100-n) are base stations and transmit user-specific signals to the plurality of receiving devices (102-1, 102-2, . . . , 102-n) may also fall within the scope of the present embodiment.

Hereinafter, for convenience of description, it is assumed that the plurality of transmitting devices (100-1, 100-2, . . . , 100-n) transmit wireless signals to a single receiving device (102-1, 102-2, . . . , 102-n).

In one embodiment, an AI-based user separation system operating in a shared embedding space includes transmitting devices (100-1, 100-2, . . . , 100-n) that (i) map a user's data sequence to first embedding data using a first positional encoding for semantic identification, (ii) map the first embedding data to second embedding data using a second positional encoding for user identification, and (iii) output the second embedding data.

An embedding-domain multiplexer combines the second embedding data from multiple transmitters by embedding-space superposition into a single multiplexed signal. A receiving device (102-1, 102-2, . . . , 102-n) equipped with a Transformer Decoder or Transformer encoder-decoder receives the multiplexed signal, performs attention-driven masking and AI-based alignment conditioned on user-specific information to separate user signals in the embedding domain, and decodes semantic information for each user.

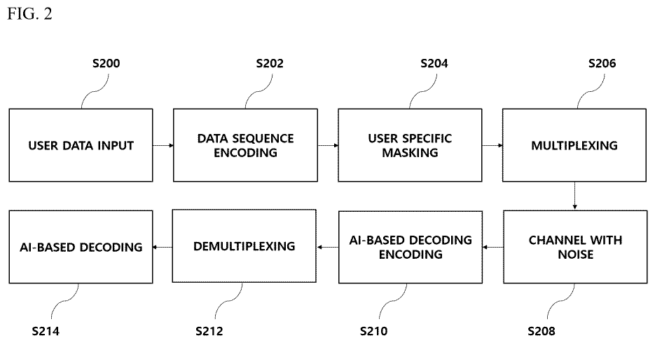

FIG. 2 is a diagram illustrating a multiplexing wireless communication process for AI-based user separation according to the present embodiment.

Referring to FIG. 2, each transmitting device (100-1, 100-2, . . . , 100-n) receives a data sequence input or requested by a user (step 200) and transforms the data sequence into first embedding data by applying a first positional encoding for semantic identification of the data sequence (step 202).

Subsequently, the first embedding data is transformed into second embedding data by applying a second positional encoding for user identification (step 204).

The first positional encoding emphasizes task-level semantic features within the sequence order, thereby capturing contextual relationships. The second positional encoding emphasizes user identification and is applied to increase separation among users in the embedding space according to a distance metric selected from cosine distance, Euclidean distance, angular distance, or Mahalanobis distance. Mapping with the second positional encoding can be implemented by element-wise multiplication, element-wise addition, or a hybrid thereof.

At this time, the second embedding data of each of the plurality of transmitting devices (100-1, 100-2, . . . , 100-n) is integrated into a single multiplexed signal (step 206), which is transmitted over a communication channel modeled with additive white Gaussian noise (AWGN) and optional fading (e.g., Rayleigh or Rician) (step 208).

The embedding-domain multiplexer forms the single multiplexed signal by a weighted sum or an average of the second embedding data, optionally with a normalization factor based on the number of users to maintain scale stability.

The receiving device (102-1, 102-2, . . . , 102-n) receives the single multiplexed signal and outputs an encoding result of the single multiplexed signal (step 210), and identifies each user signal by retrieving the second parameter based on artificial intelligence (AI) (step 212).

The receiving device (102-1, 102-2, . . . , 102-n) applies a Transformer encoder to produce a hidden state, and applies a Transformer decoder with masked multi-head attention conditioned on the second positional encoding to recover user-specific embeddings. Attention-driven masking comprises computing user-specific masks from the second positional encoding and applying the masks to cross-attention between the hidden state and decoder inputs. From the recovered embeddings, the receiver reconstructs, for each user, at least one of a symbol sequence, a class label, and a reconstructed sample.

The receiving device (102-1, 102-2, . . . , 102-n) may estimate an alignment factor that quantifies attention-driven interference alignment among users and adjust masking based on this factor to further improve separation robustness.

Subsequently, the receiving device (102-1, 102-2, . . . , 102-n) extracts the semantic information of each user's data sequence included in the identified user signals (step 214).

Here, the second positional encoding may also be shared in advance between the transmitting and receiving devices, or may be acquired implicitly.

The multiplexing wireless communication for AI-based user separation according to the present embodiment may be implemented through a Transformer-based encoder and decoder.

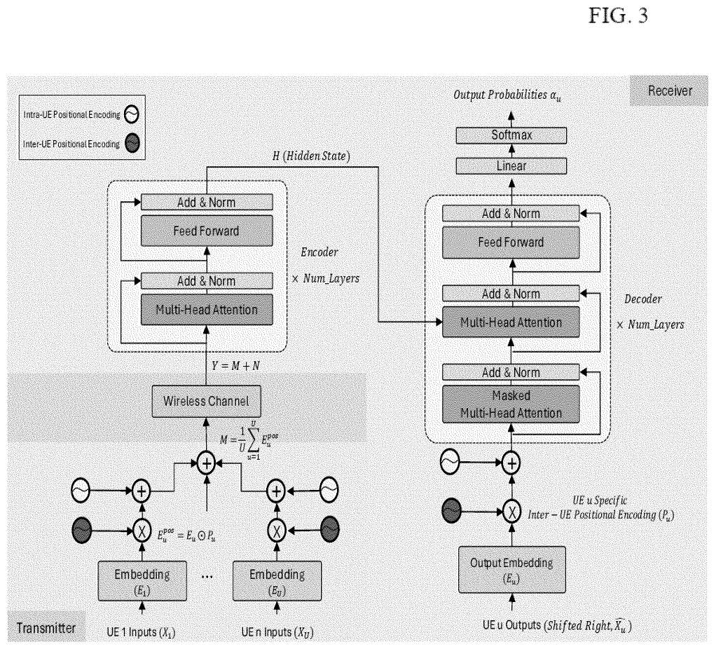

FIG. 3 is a diagram illustrating a multiplexing wireless communication scheme for AI-based user separation based on a Transformer according to the present embodiment.

Referring to FIG. 3, each user's data sequence is represented as Xᵤ=[x_{u,1}, x_{u,2}, . . . , x_{u,T}], Here, Xᵤ denotes the entire data sequence of user u; x_{u,t} denotes the t-th symbol or data element in the sequence of user u; and T denotes the sequence length.

Each transmitting device (100-1, 100-2, . . . , 100-n) transforms the input data sequence into high-dimensional embedding data using a learnable embedding layer, which is represented as Eᵤ=[E_{u,1}, e_{u,2}, . . . , e_{u,T}], where d denotes the embedding dimension.

Each transmitting device (100-1, 100-2, . . . , 100-n) applies a first positional encoding to the data sequence and transforms the data sequence into first embedding data as described above.

Here, the first positional encoding may be defined as an Intra-UE positional encoding vector, in that it is used for semantic identification according to the order of data within the data sequence.

Through this transformation, meaningful contextual relationships within each user's data sequence can be captured, thereby providing a robust foundation for multiplexing.

In addition, the transmitting devices (100-1, 100-2, . . . , 100-n) according to the present embodiment applies a second positional encoding to the first embedding data for user identification and transforms it into second embedding data.

Here, the second positional encoding may be defined as an Inter-UE positional encoding vector, in that it is used for user identification.

Hereinafter, the Inter-UE positional encoding vector will also be referred to as a user-specific positional encoding.

At the receiving device (102-1, 102-2, . . . , 102-n), the second positional encoding may be applied to encoder outputs to form user-specific decoder inputs by element-wise interaction between a user encoding and an output embedding. The first and second positional encodings are implemented as distinct trainable vectors or matrices of a common embedding dimension.

Unlike conventional Transformers, which mainly rely on fixed positional encodings for representing data sequences, the present embodiment introduces user-specific learnable positional encodings, thereby enabling efficient and scalable user multiplexing in dense wireless communication environments.

For each user u, a unique learnable user-specific positional encoding Pᵤ is defined as a trainable parameter having an embedding dimension d.

Such user-specific encodings are initialized with random values and are optimized through a training process together with other parameters by means of various AI learning models, including Transformer models.

The learnable nature of Pᵤ allows the system to dynamically adjust the encoding in order to minimize interference and maximize separability among users during shared channel communication.

The user-specific positional encoding Pᵤ is integrated with the first embedding data Eᵤ of the user through an element-wise product

$${E}_{u}^{pos} = {E}_{u} ⊙ {P}_{u} ,$$

thereby being transformed into second embedding data.

Here, the ⊙operator may be defined as various operations, including element-wise multiplication, addition, or a hybrid of multiplication and addition. This operator is also designed to enlarge the inter-user distance in the embedding space, thereby facilitating clearer separation among users and reducing potential interference.

In this manner, the system according to the present embodiment can simultaneously process multi-user data while maintaining user separability by assigning a unique learnable user-specific positional encoding to each user.

Accordingly, explicit signaling or predefined allocation for user identification is not required, thereby reducing control overhead and enhancing scalability in dense user scenarios.

The second embedding data of each transmitting device (100-1, 100-2, . . . , 100-n) is integrated into a single multiplexed signal, which is defined as

$$M = \frac{1}{U} {\sum }_{u = 1}^{U} {E}_{u}^{pos} ,$$

where U denotes the total number of users.

Then, the single multiplexed signal is transmitted through a shared channel modeled as Y=M+N, where N represents additive white Gaussian noise (AWGN) with noise power σ².

As illustrated in FIG. 3, the receiving device (102-1, 102-2, . . . , 102-n) according to the present embodiment may include an encoder and a decoder.

The signal Y received by the receiving device (102-1, 102-2, . . . , 102-n) is processed through a Transformer encoder, whereby contextual relationships are captured and noise is mitigated.

The encoder output is calculated as H=TransformerEncoder (Y, P) where P is a positional encoding matrix that preserves sequence order information.

Within the encoder, multi-head self-attention is employed to extract meaningful features, namely queries, keys, and values.

Specifically, the queries, keys, and values are calculated as Q=YW_{Q}, K=YW_{K}, and V=YW_{V}, where W_{Q}, W_{K} and W_{V} are learned weight matrices, and the attention output is calculated as

$$H = Softmax ( \frac{{QK}^{⊤}}{\sqrt{{d}_{k}}} ) V .$$

User-specific signals are separated using an attention mechanism.

Here, a user-specific query Qᵤ is given as Qᵤ=MᵤW_{Q}, and the key K_{H} and the value V_{H} are obtained from the Transformer encoder output as K_{H}=HW_{K} and V_{H}=HW_{V}, respectively.

Then, the attention weight αᵤ is calculated as

$${α}_{u} = Softmax ( \frac{{Q}_{u} {K}_{H}^{⊤}}{\sqrt{{d}_{k}}} ) ,$$

and user-specific second embedding data can be retrieved through the weighted sum gᵤ=αᵤV_{H}.

After the user-specific signals are separated in this manner, a reconstruction process of the user data sequences is performed through a Transformer decoder.

The user-specific second embedding data gᵤ is passed through a Transformer decoder, and the Transformer decoder reconstructs the original user data sequence as \hat{X}ᵤ.

Hereinafter, a system evaluation process according to the present embodiment will be described.

First, a random symbol sequence is generated for each user, and each sequence consists of T symbols. These sequences are embedded into a d-dimensional space using a learnable embedding layer.

The embedding sequence of each user is represented as first embedding data Eᵤ.

This embedding step allows user-specific data to be mapped into a high-dimensional space for efficient processing.

Subsequently, when a user-specific positional encoding vector is applied to the first embedding data to generate second embedding data, the second embedding data of all users are averaged to perform multiplexing.

The Transformer model processes the noisy single multiplexed signal to reconstruct the original user-specific data.

The training objective is to minimize the cross-entropy loss, which quantifies the difference between the actual symbol x_{u,t} and the predicted symbol \hat{x}_{u,t}. By minimizing this loss, the model learns to accurately reconstruct user data even when the single multiplexed signal is corrupted by noise.

Finally, the performance of the system is evaluated across various SNR levels and user counts.

Parameters of the first positional encoding, the second positional encoding, and the Transformer encoder-decoder are jointly learned in an end-to-end pre-training stage and stored for inference. In one variant (unified training), token-level samples are drawn across multiple channel environments using a single parameter set to promote SNR-agnostic generalization. In another variant (per-channel training), separate parameter sets are trained for different channel environments. A contrastive objective (e.g., InfoNCE) may be included in addition to a primary task loss (e.g., cross-entropy or mean-squared error) to increase inter-user separation in the embedding space.

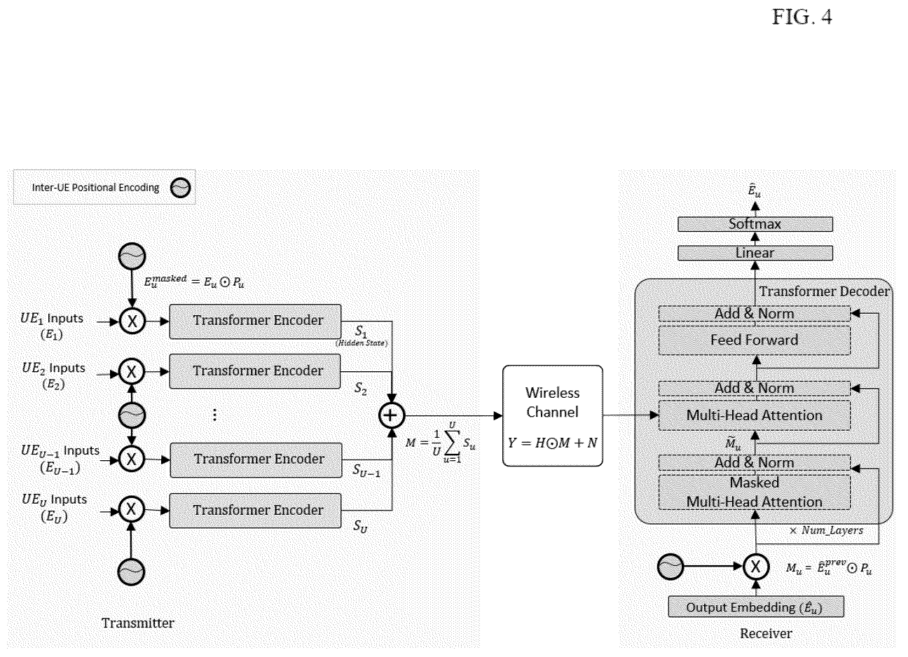

FIG. 4 is a diagram illustrating a multiplexing wireless communication method for Transformer-based user separation according to another embodiment of the present invention.

The Transformer encoder may be located at the transmitter depending on the system configuration and communication objectives. In particular, when deployed at the transmitting device (100-1, 100-2, . . . , 100-n), the encoder generates semantic representations that are robust to channel distortion.

As shown in FIG. 4, when the Transformer encoder is located on the transmitting side, the encoder converts second embedding data

$$( {E}_{u}^{masked} = {E}_{u} ⊙ {P}_{u} )$$

into hidden states (Sᵤ); an embedding-domain multiplexer superposes the hidden states from the plurality of transmitting devices (100-1, 100-2, . . . , 100-n) into a single multiplexed signal Y=H⊙M+N).

Table 1 illustrates the key parameters used in the experiments, including typical configurations in multi-user communication scenarios. Parameters such as sequence length (T=10), embedding dimension (d=128), and SNR levels ({0,5,10,15,20,25}) are selected to evaluate the scalability and robustness of the system.

TABLE 1

| Parameter | Value/Description |
|---|---|
| Number of Users (U) | {2, 4, 8, 16, 32, 64} |
| Sequence Length (T) | 4 symbols |
| Embedding Dimension (d) | 128 |
| Vocab Size (C) | 4 |
| Transformer Layers | 4 |
| Attention Heads | 8 |
| Hidden Dimension (h) | 128 |
| Channel Model | AWGN |
| SNR Levels (SNR_{dB}) | {0, 5, 10, 15, 20, 25} |
| Batch Size(N_{b}) | 400 |
| Epochs | 30 |
| Optimizer | AdamW (LR = 10⁻⁴) |
| Loss Function | CrossEntropyLoss |
| Visualization Parameters | PCA, Correlation Heatmap for 10 Users |

Principal Component Analysis (PCA) is used to analyze the independence of the user-specific positional encoding Pᵤ for each user u. The objective is to reduce dimensionality while preserving as much variance as possible and to evaluate the relationships among these user-specific positional encodings. Initially, the positional encodings of all users are organized into a matrix P, where U is the number of users and d is the dimensionality of each positional encoding.

To ensure zero-centered data, a mean vector p̅, calculated as the average of all rows of P, is subtracted from PPP. This subtraction produces a zero-centered positional encoding matrix, denoted as P′=P−p̅, where each row of P′ corresponds to a centered positional encoding.

Next, a covariance matrix M is computed to capture the relationships among the dimensions of the zero-centered positional encodings. The covariance matrix is defined as

$$M = \frac{1}{U} {P}^{′ ⊤} {P}^{′} ,$$

where U denotes the number of users.

This covariance matrix serves to identify the principal components of the user-specific positional encodings. The covariance matrix M is decomposed into eigenvalues λ and eigenvectors u, which satisfy Mu=λu.

Here, each eigenvalue λᵢ represents the variance explained by its corresponding eigenvector uᵢ.

To prioritize the most informative dimensions, the eigenvalues are sorted in descending order, and the top k eigenvectors are arranged in a matrix Vₖ.

Here, k<d. Finally, the positional encodings are projected onto these principal components to obtain a reduced-dimensional representation calculated as Z=P′Vₖ, where Z represents the compressed representation of the positional encodings.

PCA provides an additional perspective on the independence and separability of the positional encodings, complementing the analysis offered by other metrics.

Positional Correlation (PC) quantifies the independence of user-specific positional encodings by analyzing pairwise relationships. After applying PCA to reduce the dimensionality of the positional embeddings, a pairwise correlation matrix is computed. The mean absolute correlation, excluding the diagonal elements, is calculated as follows:

$$PC = \frac{1}{U ( U - 1 )} {\sum }_{i \neq j} \vert {C}_{ij} \vert , \qquad [ Equation 1 ]$$

Here, Cᵢⱼ represents the correlation coefficient between the user-specific positional encodings of users i and j. A lower value of PC indicates higher independence among user-specific positional encodings, thereby reducing inter-user interference and enhancing the robustness of demultiplexing in dense multi-user scenarios.

Reconstruction Loss (RL) measures the average discrepancy between the actual probability and the predicted probability across all users and sequences. It is computed by averaging the cross-entropy loss over all users, time steps, and classes. For a given user u, at sequence t, and for a vocabulary class c, the actual probability is denoted as x_{u, t, c}, and the predicted probability is denoted as \hat{x}_{u, t, c}.

The reconstruction loss is expressed as an average over all users, sequences, and batches, as follows:

$$ℛℒ = \frac{1}{U \times T \times {N}_{b}} {\sum }_{b = 1}^{{N}_{b}} {\sum }_{u = 1}^{U} {\sum }_{t = 1}^{T} {\sum }_{c = 1}^{C} - {x}_{u , t , c} log ( {\hat{x}}_{u , t , c} ) , \qquad [ Equation 2 ]$$

Here, U denotes the total number of users, T denotes the sequence length, C denotes the vocabulary size, and N_{b} denotes the number of batches.

The loss in Equation (2) is normalized across all users, time steps, and batches, thereby providing a consistent measure of the system's reconstruction performance.

Reconstruction Accuracy (RA) quantifies the proportion of symbols correctly reconstructed across all users and time steps.

For user u, the actual symbol in the vocabulary is represented as x_{u,t}, and the predicted symbol is represented as \hat{x}_{u,t}. The accuracy is calculated as follows:

$$ℛ𝒜 = \frac{{\sum }_{u = 1}^{U} {\sum }_{t = 1}^{T} \text{?} ( {\hat{x}}_{u , t} = {x}_{u , t} )}{U \times T \times {N}_{b}} \times 100 , \qquad [ Equation 3 ]$$

Here, [symbol] (⋅) denotes an indicator function that returns 1 if the predicted symbol matches the actual symbol, and 0 otherwise.

This metric is intended to provide a simple measure of the system's ability to accurately reconstruct user-specific data.

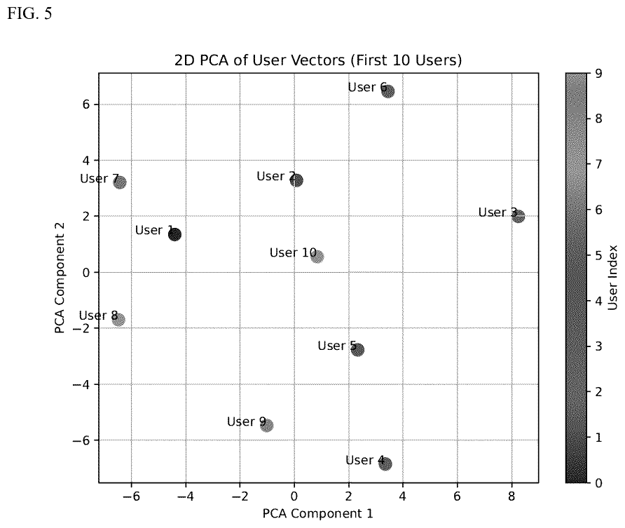

FIG. 5 illustrates a PCA visualization of user-specific positional encodings.

In FIG. 5, the embeddings are reduced to two dimensions for interpretability, each point represents a user, and the distribution demonstrates effective separation of user-specific signals.

This shows the system's ability to generate distinct embeddings that not only minimize interference during multiplexing and demultiplexing processes through a uniform distribution, but also ensure independent representations for each user.

The effectiveness of the user-specific positional encoding mechanism is evaluated through correlation analysis and epoch-wise loss trends, which demonstrate the multiplexing capacity of the system.

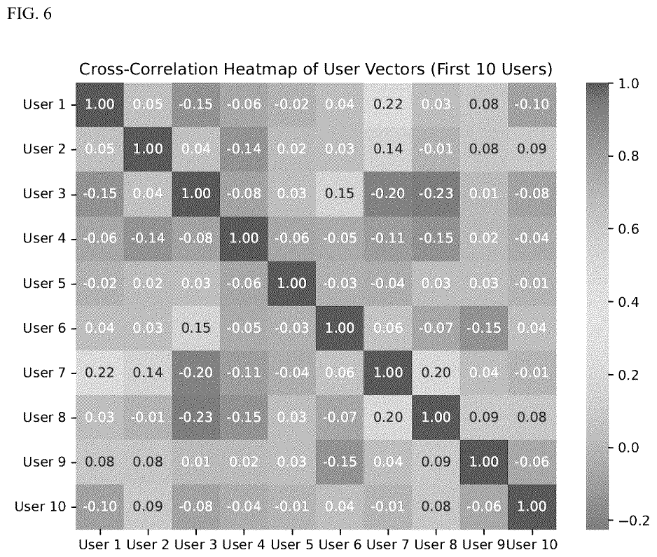

FIG. 6 illustrates pairwise correlations between positional encodings for 10 users. In FIG. 6, low off-diagonal values indicate minimal interference and strong independence among user-specific positional encodings, which is essential for stable demultiplexing.

During training, the off-diagonal elements of the correlation heatmap approach zero, demonstrating the model's ability to learn unique positional embeddings for each user. This enables the system to minimize shared information among embeddings while effectively separating user data.

The epoch-wise loss trends show that the loss decreases rapidly during the initial epochs and then stabilizes across various SNR levels, thereby further ensuring system performance. As the SNR increases, convergence is accelerated and the loss values decrease, indicating that the model has improved ability to reconstruct user-specific data under favorable conditions.

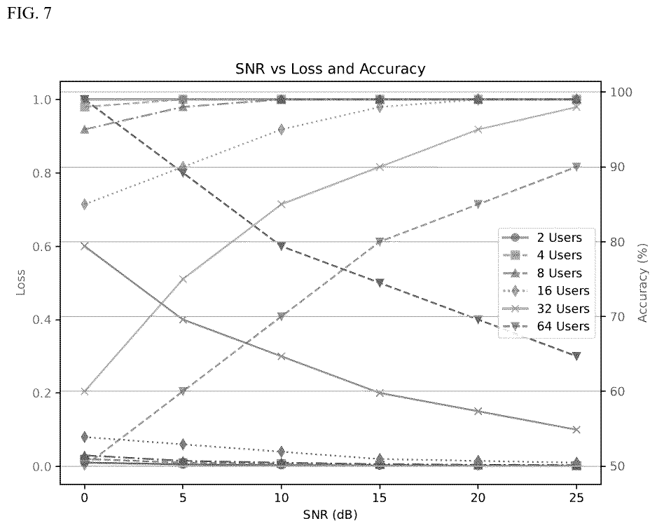

FIG. 7 illustrates the relationship among SNR, loss, and accuracy.

As the SNR increases, the loss decreases significantly across all configurations. This trend is particularly pronounced at low SNR values (e.g., 0 dB and 5 dB), where the higher loss is due to the substantial impact of noise.

At higher SNR values (e.g., 20 dB and 25 dB), the loss converges to a minimum, indicating good performance under low-noise conditions. Among the configurations, those with fewer multiplexing users (e.g., four users) consistently exhibit lower loss, thereby confirming the trade-off between user capacity and system performance.

At the same time, accuracy improves as the SNR increases, reaching nearly 100% at higher SNR values (e.g., 20 dB and 25 dB) across all configurations. At lower SNR values (e.g., 0 dB), configurations with fewer users (e.g., four users and eight users) achieve significantly higher accuracy compared to configurations with more users (e.g., sixteen users and thirty-two users).

This demonstrates that the system is vulnerable to noise under high user density; however, as the SNR improves, the accuracy gap between configurations narrows, indicating the model's ability to effectively adapt and recover performance under improved channel conditions.

The ability of the system to effectively distinguish users depends on several factors, including the embedding space dimension, the vocabulary size, and the reconstruction method. The total capacity of the system is determined by the d-dimensional embedding space shared among all concurrent users within a transmission time interval (TTI). For U users, the total required embedding space is U·V, where V represents the embedding dimension per user.

When the total available embedding space is d, the maximum user capacity of the system is constrained by the inequality U·V≤d.

Rearranging this relationship, the maximum number of supported users can be approximated as:

$${U}_{max} \approx \frac{d}{V} . \qquad [ Equation 4 ]$$

By substituting the experimental values d=128 and V=4 into the equation, the maximum user capacity is approximately 32. This theoretical limit represents the maximum number of users that can be supported in the absence of noise or interference.

However, in practical scenarios, factors such as channel noise, interference, and the quality of user-specific positional encodings reduce the effective capacity of the system. The system according to the present embodiment was observed to maintain more than 90% accuracy for up to 32 users, which is consistent with the theoretical limit. When this capacity is exceeded, as in the case of 64 users, performance significantly degrades, making the impact of exceeding the embedding space capacity on system efficiency more pronounced.

A computer-readable medium storing a computer program for performing the multiplexing wireless communication method for AI-based user separation according to the present invention, as described above, may be provided. Furthermore, the multiplexing wireless communication method for AI-based user separation described above may be implemented as code readable by a computer on a computer-readable recording medium. The computer-readable recording medium may include any type of storage medium in which data decodable by a computer system is stored, such as ROM (Read Only Memory), RAM (Random Access Memory), magnetic tape, magnetic disk, flash memory, or optical data storage devices. In addition, the computer-readable recording medium may be distributed across computer systems connected via a communication network and stored and executed in a distributed manner as code readable by the computers.

The embodiment of the present invention described above is disclosed for illustrative purposes, and those skilled in the art will appreciate that various modifications, alterations, and additions can be made within the spirit and scope of the invention. Such modifications, alterations, and additions should be construed as falling within the scope of the claims appended hereto.

What is claimed is:

1. A multiplexing wireless communication system operating in a shared embedding space over a communication channel for AI-based user separation, comprising:
a plurality of transmitting devices, each configured to:
map a user's data sequence to first embedding data using a first positional encoding for semantic identification;
map the first embedding data to second embedding data using a second positional encoding for user identification; and
output the second embedding data;
an embedding-domain multiplexer configured to combine, by embedding-space superposition, the second embedding data from the plurality of transmitting devices into a single multiplexed signal; and
a receiving device configured to:
receive the single multiplexed signal;
perform attention-driven masking and AI-based alignment conditioned on user-specific information to separate user signals in the embedding-domain multiplexer; and
decode semantic information for each user.

2. The system of claim 1, wherein the first positional encoding emphasizes task-level semantic features and the second positional encoding emphasizes the user identification.

3. The system of claim 1, wherein mapping with the second positional encoding is implemented by an operator selected from element-wise multiplication, element-wise addition, or a hybrid of multiplication and addition.

4. The system of claim 3, wherein the second positional encoding is configured or trained to increase separation among embedding vectors of different users in the shared embedding space according to a distance metric selected from cosine distance, Euclidean distance, angular distance, or Mahalanobis distance, thereby facilitating subsequent user-specific separation.

5. The system of claim 1, wherein the embedding-domain multiplexer forms the single multiplexed signal by a weighted sum or average of the second embedding data, optionally with a normalization factor based on the number of users.

6. The system of claim 1, wherein the plurality of transmitting devices comprises a Transformer encoder and the receiving device comprises a Transformer decoder, the Transformer encoder converts the second embedding data to a hidden state, the embedding-domain multiplexer superposes the hidden state from the plurality of transmitting devices into the single multiplexed signal, the Transformer decoder with masked multi-head attention conditioned on the second positional encoding to recover user-specific embeddings.

7. The system of claim 1, wherein the receiving device comprises a Transformer encoder and a Transformer decoder, the Transformer encoder to the single multiplexed signal to produce a hidden state, and applies the Transformer decoder with masked multi-head attention conditioned on the second positional encoding to recover user-specific embeddings.

8. The system of claim 7, wherein the attention-driven masking comprises computing user-specific masks from the second positional encoding and applying the user-specific masks to cross-attention between the hidden state and decoder inputs.

9. The system of claim 7, wherein the receiving device reconstructs, for each user, at least one of: a symbol sequence, a class label, and a reconstructed sample, from the recovered user-specific embeddings.

10. The system of claim 7, wherein parameters of the first positional encoding, the second positional encoding, and the Transformer encoder and the Transformer decoder are jointly learned in an end-to-end pre-training stage and stored for inference.

11. The system of claim 10, wherein the pre-training stage includes unified training in which token-level samples are drawn across multiple channel environments using a single parameter set.

12. The system of claim 10, wherein the pre-training stage includes per-channel training in which separate parameter sets are trained for different channel environments.

13. The system of claim 10, wherein the pre-training stage further includes a contrastive objective that increases inter-user separation in the shared embedding space using an InfoNCE (Information Noise-Contrastive Estimation) loss.

14. The system of claim 1, wherein the second positional encoding is applied to encoder outputs at the receiving device to form user-specific decoder inputs by element-wise interaction between a user encoding and an output embedding.

15. The system of claim 1, wherein the first positional encoding and the second positional encoding are implemented as distinct trainable vectors or matrices of a common embedding dimension.

16. The system of claim 1, wherein the receiving device estimates an alignment factor that quantifies attention-driven interference alignment among users and adjusts masking based on the alignment factor.

17. A method for multiplexing wireless communication in a shared embedding space over a communication with AI-based user separation, comprising:
mapping, by a plurality of transmitting devices, each user's data sequence to first embedding data using a first positional encoding for semantic identification;
mapping, by the plurality of transmitting devices, the first embedding data to second embedding data using a second positional encoding for user identification; combining, by embedding-space superposition, the second embedding data into a single multiplexed signal;
receiving, by a receiving device, the single multiplexed signal; and
separating user signals and decoding semantic information by applying attention-driven masking and AI-based alignment.

18. The method of claim 17, further comprising optimizing a contrastive loss to enforce inter-user separation in the shared embedding space in addition to a primary task loss selected from cross-entropy and mean-squared error.

19. The method of claim 17, wherein the mapping the first embedding data to the second embedding data using the second positional encoding comprises applying an operator selected from element-wise multiplication, element-wise addition, or a hybrid of multiplication and addition.

20. The method of claim 19, wherein the second positional encoding is configured to increase separation among embedding vectors of different users in the shared embedding space according to a distance metric selected from cosine distance, Euclidean distance, angular distance, or Mahalanobis distance, thereby facilitating subsequent user-specific separation.
